(19) United States
(12) Patent Application Publication
(10) Pub. No.: US 2021/0172591 A1
(43) Pub. Date: Jun. 10, 2021

(54) LIGHTING SYSTEM

(71) Applicant: AVID Labs, LLC, Fort Wayne, IN (US)

(72) Inventors: Joel A. Nichols, Columbia City, IN (US); Michael F. Esmonde, Orlando, FL (US); Andrew Trenton, Fort Wayne, IN (US)

(73) Assignee: AVID Labs, LLC, Fort Wayne, IN (US)

(21) Appl. No.: 17/111,605

(22) Filed: Dec. 4, 2020

Related U.S. Application Data
(60) Provisional application No. 62/943,560, filed on Dec. 4, 2019.

(51) Int. Cl. F21V 23/04; F21V 23/00; F21L 4/02

(52) U.S. Cl. CPC F21V 23/0464; F21V 23/003; F21Y 2115/10; F21V 23/0428; F21L 4/027

(57) ABSTRACT

A lighting system that includes a lighting device configured to be removably connected to a transportation device. The lighting device includes a body, at least one visible light source connected to the body, the at least one visible light source is configured for emitting visible light, and at least one ultraviolet light source connected to the body. The at least one ultraviolet light source is configured for emitting ultraviolet light such that a reflectance material of an object, which is not being illuminated by the at least one visible light source, is illuminated by the at least one ultraviolet light source.

### CROSS REFERENCE TO RELATED APPLICATIONS

This is a non-provisional application based upon U.S. provisional patent application Ser. No. 62/943,560, entitled “LIGHTING SYSTEM”, filed Dec. 4, 2019, which is incorporated herein by reference.

### BACKGROUND OF THE INVENTION

### 1. Field of the Invention

The invention relates to lighting systems, and, more particularly, to a lighting system for a transportation device which emits both visible light and non-visible light.

### 2. Description of the Related Art

Low-light conditions may present a hazard to individuals who are not well-lit. Personal protective equipment, such as a reflective clothing, is often used to promote visibility. However, personal protective equipment may not be effective if such equipment is not sufficiently illuminated. Thereby, individuals may need to be sufficiently illuminated by various auxiliary lights.

Some auxiliary lights may include light emitting diodes (LEDs). The introduction of LED lighting technology has reduced much of the ultraviolet (UV) radiation emitted from an artificial source to near zero. While the efficiency of the LED lighting is very desirable, the use thereof alters the spectral breadth of the light being produced. The lack of UV light degrades the effectiveness of safety markings placed on equipment, vehicles, and clothing worn by operators or security personnel, in that many of such markings are designed to fluoresce, which requires the presence of UV spectral power.

UV light is an electromagnetic radiation with a wavelength from roughly 10 nm (30 PHz) to 380 nm (750 THz), which is a shorter wavelength than that of visible light but longer than X-rays. UV radiation is present in sunlight, and also produced by electric arcs and specialized lights such as mercury-vapor lamps, tanning lamps, and black lights. Although the UV light lacks the energy to ionize atoms, long-wavelength ultraviolet radiation can influence chemical reactions, and causes many substances to glow or fluoresce. Therefore, known artificial lighting systems may ineffectually illuminate equipment or individuals in low-light conditions.

What is needed in the art is a lighting system for providing the needed ultraviolet radiation in conjunction with visible light to improve visibility of equipment and individuals in low light conditions.

### SUMMARY OF THE INVENTION

The invention provides a lighting system that includes a lighting device for emanating visible light and ultraviolet light. The lighting device may be a handheld lighting device which is removably mounted on a transportation device. The lighting device includes a body, at least one visible light source connected to the body, and at least one ultraviolet light source connected to the body. The at least one ultraviolet light source can illuminate one or more objects, including clothing of the operator of the transportation device.

The invention in one form is directed to a lighting system that includes a lighting device configured to be removably connected to a transportation device. The lighting device includes a body, at least one visible light source connected to the body, the at least one visible light source is configured for emitting visible light, and at least one ultraviolet light source connected to the body. The at least one ultraviolet light source is configured for emitting ultraviolet light such that a reflectance material of an object, which is not being illuminated by the at least one visible light source, is illuminated by the at least one ultraviolet light source.

The invention in another form is directed to a lighting system that includes a transportation device and a lighting device removably connected to the transportation device. The lighting device includes a body, at least one visible light source connected to the body, the at least one visible light source is configured for emitting visible light, and at least one ultraviolet light source connected to the body. The at least one ultraviolet light source is configured for emitting ultraviolet light such that a reflectance material of an object, which is not being illuminated by the at least one visible light source, is illuminated by the at least one ultraviolet light source.

The invention in another form is directed to a method for illuminating at least one of an area and an object. The method includes providing a transportation device and a lighting device removably connected to a transportation device. The lighting device includes a body, at least one visible light source connected to the body, and at least one ultraviolet light source connected to the body. The method further includes emitting at least one of visible light by activating the at least one visible light source and ultraviolet light by activating the at least one ultraviolet light source such that a reflectance material of the object, which is not being illuminated by the at least one visible light source, is illuminated by the at least one ultraviolet light source.

An advantage of the invention is that the lighting system dually emits UV light and visible light for illuminating an area in front of the individual and transportation device and illuminating an object being worn by the individual.

Another advantage of the invention is that the lighting system is that the UV light and the visible light emit in opposing directions for illuminating the individual and an area in front of the individual.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic view of a lighting system according to an embodiment of the invention, wherein the lighting system is removably coupled to a transportation device and is operating in a dual state for emanating nonvisible and visible light;

FIG. 2 is a schematic view of the lighting system of FIG. 1, wherein the lighting system is operating in a visible light state for emanating only visible light;

FIG. 3 is a schematic view of another embodiment of a lighting system, wherein the lighting system is in the form of a handheld flashlight which can be removably coupled to a transportation device;

FIG. 4 is a schematic view of the lighting system of FIG. 3, wherein the lighting system is carried by an individual and the lighting system is operating in the visible light state;

FIG. 5 is a schematic view of the lighting system of FIGS. 3-4, wherein the lighting system is carried by the individual and the lighting system is operating in a nonvisible light state for emanating only nonvisible light;

FIG. 6 is a schematic view of the lighting system of FIGS. 3-5, wherein the lighting system is carried by the individual and the lighting system is operating in the dual state; and

FIG. 7 is a schematic view of another embodiment of a lighting system, wherein the lighting system includes a control device for automatically activating the various lighting states of the lighting system.

Corresponding reference characters indicate corresponding parts throughout the several views. The exemplifications set out herein illustrate embodiments of the invention and such exemplification are not to be construed as limiting the scope of the invention in any manner.

### DETAILED DESCRIPTION OF THE INVENTION

As used herein, the term visible light refers to the spectrum of light which the human eye can see without the aid of some device. The term non-visible light refers to what the human eye cannot see without the aid of some device. The term ultraviolet (UV) light refers to electromagnetic radiation with a wavelength from roughly 10 nm (30 PHz) to 380 nm (750 THz).

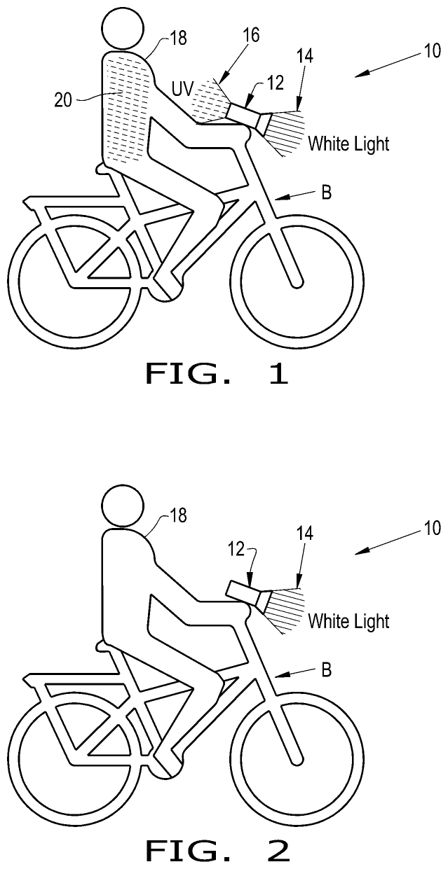

Referring now to the drawings, and more particularly to FIGS. 1-2, there is shown, in a schematic form, a lighting system 10. The lighting system 10 may be in the form of a light source 12. The light source 12 may be removably mounted to a transportation device, such as a gas or electric powered vehicle or a manpowered vehicle. The transportation device may be in the form of a bicycle B. The light source 12 has a body and emits visible light 14 and non-visible light 16. The non-visible light 16 may be in the form of UV light 16.

When UV light 16 illuminates and interacts with reflectance material(s) 18. The reflectance material(s) will 18 convert UV light 16 into visible light 20 to enhance the visibility of the operator, individuals, and/or objects, including the bicycle B. A reflectance material 18 may include any desired material, paint, coating, fabric, etc., which phosphors, i.e., emits visible light upon absorbing UV radiation. It should be appreciated that an object may include any desired object or thing, personnel, and/or animal. For example, the object may be in the form of an article of clothing, such as a safety vest or shirt, worn by the individual. Additionally, for example, the object may be in the form of markings on the bicycle B. By way of example only, the rider of bicycle B is shown wearing an article of clothing with reflectance materials 18, and the UV light 16 interacts with reflectance materials 18 such that reflectance materials 18 convert UV light 16 into visible light 20 to enhance the visibility of the operator.

In FIG. 1, the lighting system 10 is shown to be operating in a dual state for emanating both lights 14, 16. In FIG. 2, the lighting system 10 is shown to be operating in a visible light state for emanating only visible light 14.

The lighting system 10 may be in the form of a handheld or wearable device which may be carried by an individual or used on one or more transportation devices. Thereby, the lighting system 10 may be removably connected to a transportation device. The light source 12 may have vehicle and non-vehicle applications. The lighting system 10 may have one or more mating features which couple to one or more mating features on the transportation device. For instance, the lighting system 10 may have rail members which interact with channels in a mount affixed to the bicycle B. Additionally and/or alternatively, the lighting system 10 may be removably connected to the transportation device via one or more fasteners, e.g. screws, Velcro®, etc. The lighting system 10 has a selectable emission of UV light 16 and visible light 14. It should be appreciated that the lights may also be directed by one or more light directing devices, e.g. cones.

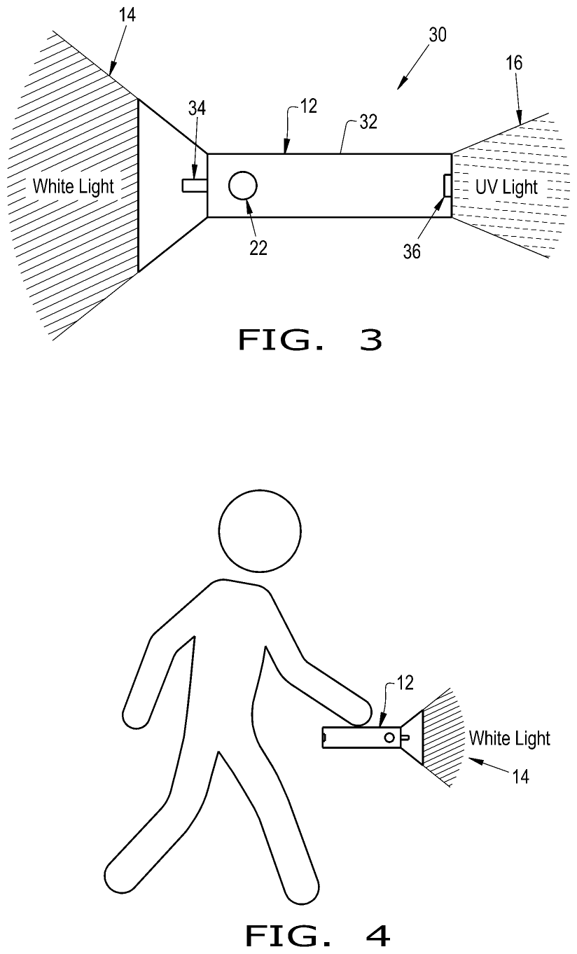

Now, referring to FIG. 3, there is shown another embodiment of a lighting system 30. In the lighting system 30, the light source 12 is in the form of a handheld flashlight 32. The flashlight 32 includes a body and light(s) 34, 36, e.g. light emitting diodes (LEDs), which respectively emit the visible and nonvisible light 14, 16. The flashlight 32 includes a control 22 that selectively turns on/off lights 14, 16. The control 22 may be in the form of a switch or button 22 connected to the body.

The flashlight 32 may include one or more LEDs 34 for emitting visible light 14 and one or more LEDs 36 for emitting nonvisible light 16. The LEDs 34, 36 may be connected to the opposing ends of the body. The lights 14, 16 may emanate from opposite ends of the body of the light source 12. The ends of the flashlight 32 may have one or more light directing devices, e.g. cones, for directing the visible and nonvisible light 14, 16. The LED(s) 36 may include a widened spectrum including UV light emitting sources and visual light emitting sources, for example, with a spectrum from 360 nm to 385 nm, for example from 360 nm to 670 nm. The lights 34, 36 can be connected to the body of the lighting device in any desired fashion. The lights 34, 36 may be positioned within or on the body of the light source 12 at any desired location. If multiple lights are including in the flashlight 32, the visible lights 34 or the UV lights 36 may be positioned on a common substrate or die. It should be appreciated that lights 14, 16 may be emitted by any desired light sources.

The flashlight 32 may include one or more mating features and/or fasteners which removably engage with one or more mating features and/or fasteners on the bicycle B. Additionally, the flashlight 32 may not include a designated mating feature and may instead fit within a corresponding mount, e.g. clip, recess, or other receiving member, on the bicycle B.

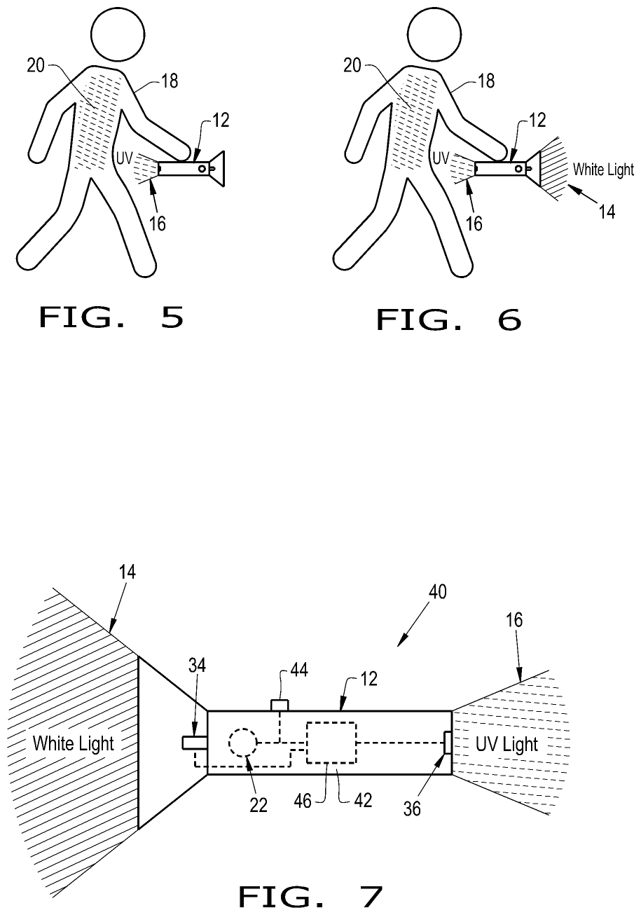

Now, additionally referring to FIGS. 4-6, there are shown three different states of the light source 12. In FIG. 4, only visible light 14 is illuminated. In FIG. 5, only nonvisible light 16 is illuminated. A combination of lights 14, 16 are both shown illuminated in FIG. 6. In FIGS. 5-6, UV light 16 is causing the material 18 to be illuminated causing visible light 20 to emanate from material 18.

It should also be appreciated that the flashlight 32 may be powered by any desired power source. For example, the flashlight 32 may be powered by one or more batteries. Additionally, for example, the flashlight 32 may be selectively connectable to an electric power source of the transportation device.

Referring now to FIG. 7, there is shown another embodiment of a lighting system 40. The lighting system 40 may be substantially similar to the lighting system 30, except that the light source 12 is in the form of a flashlight 42 that is automatically controlled. The flashlight 42 can be switched in between its various lighting states via one or more light sensors 44 and a control device 46. Like elements have been identified with like reference characters. The flashlight 42 may or may not include the switch 22 for optional manual control.

Each light sensor 44 may be operably connected to the control device 46. Each light sensor 44 may be coupled to the body of the flashlight 42 at any desired location. Each light sensor 44 may be in the form of an optical sensor for sensing ambient light around the individual and/or bicycle B. For example, each light sensor 44 may sense ambient daylight and/or artificial light, such as street lights or headlights of vehicles. Each light sensor 44 may provide a light signal to the control device 46. For instance, each light sensor 44 may send a well-lit signal to the control device 46 upon sensing a sufficient amount of ambient light. As used herein, the term sufficient amount of ambient light may refer to a level of ambient light wherein the reflected light 20 from the UV radiation absorbed by the reflectance material(s) 18 is not brighter than the surrounding ambient light.

The control device 46 may be operably connected to the visible and ultraviolet lights 34, 36, the sensor(s) 44, and/or the switch 22 if included. The control device 46 may be located within the body of the lighting device 42. The control device 46 may be in the form of an analog and/or digital control device, such as a microcontroller. The control device 46 can selectively activate the visible and/or nonvisible LEDs 34, 36 depending upon the light signal of the light sensor 44.

While this invention has been described with respect to at least one embodiment, the invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A lighting system, comprising:
a lighting device configured to be removably connected to a transportation device, the lighting device comprising:
a body;
at least one visible light source connected to the body, the at least one visible light source being configured for emitting visible light; and
at least one ultraviolet light source connected to the body, the at least one ultraviolet light source being configured for emitting ultraviolet light such that a reflectance material of an object, which is not being illuminated by the at least one visible light source, is illuminated by the at least one ultraviolet light source.

2. The lighting system of claim 1, wherein the lighting device is a handheld lighting device.

3. The lighting system of claim 2, wherein the lighting device is configured for being removed from the transportation device and held by an individual.

4. The lighting system of claim 3, wherein the individual is the operator of the transportation device, wherein the object is worn by the individual such that the individual is illuminated by the at least one ultraviolet light source while operating the transportation device.

5. The lighting system of claim 1, wherein the body comprises a first end and a second end, wherein the at least one visible light source is connected to the first end and the at least one ultraviolet light source is connected to the second end.

6. The lighting system of claim 1, wherein the lighting device further includes a switch connected to the body, the switch being configured for activating the at least one visible light source and the at least one ultraviolet light source.

7. The lighting system of claim 1, wherein the lighting device further comprises a control device operably connected to the at least one visible light source and the at least one ultraviolet light source, the control device being configured for turning on and turning off the at least one visible light source and the at least one ultraviolet light source.

8. The lighting system of claim 7, wherein the control device is in the form of a microcontroller.

9. The lighting system of claim 7, wherein the lighting device further comprises at least one light sensor operably connected to the control device, the at least one light sensor being configured for sensing ambient light and providing a signal to the control device, wherein the control device is configured for turning the at least one ultraviolet light source on and off responsive to the signal of the at least one light sensor.

10. The lighting system of claim 1, wherein the at least one ultraviolet light source emits ultraviolet light in a wavelength range from 360 nm to 385 nm.

11. The lighting system of claim 10, wherein the at least one ultraviolet light source emits ultraviolet light at a wavelength of 365 nm.

12. A lighting system, comprising:
a transportation device; and
a lighting device removably connected to the transportation device, the lighting device comprising:
a body;
at least one visible light source connected to the body, the at least one visible light source being configured for emitting visible light; and
at least one ultraviolet light source connected to the body, the at least one ultraviolet light source being configured for emitting ultraviolet light such that a reflectance material of an object, which is not being illuminated by the at least one visible light source, is illuminated by the at least one ultraviolet light source.

13. The lighting system of claim 12, wherein the lighting device is a handheld lighting device.

14. The lighting system of claim 13, wherein the lighting device is configured for being removed from the transportation device and held by an individual.

15. The lighting system of claim 14, wherein the individual is the operator of the transportation device, wherein the object is worn by the individual such that the individual is illuminated by the at least one ultraviolet light source while operating the transportation device.

16. The lighting system of claim 12, wherein the body comprises a first end and a second end, wherein the at least one visible light source is connected to the first end and the at least one ultraviolet light source is connected to the second end.

17. The lighting system of claim 12, wherein the lighting device further includes a switch connected to the body, the switch being configured for activating the at least one visible light source and the at least one ultraviolet light source.

18. The lighting system of claim 12, wherein the lighting device further comprises a control device operably connected to the at least one visible light source and the at least one ultraviolet light source, the control device being configured for turning on and turning off the at least one visible light source and the at least one ultraviolet light source.

19. The lighting system of claim 18, wherein the lighting device further comprises at least one light sensor operably connected to the control device, the at least one light sensor being configured for sensing ambient light and providing a signal to the control device, wherein the control device is configured for turning the at least one ultraviolet light source on and off responsive to the signal of the at least one light sensor.

20. A method for illuminating at least one of an area and an object, comprising:
providing a transportation device and a lighting device removably connected to the transportation device, the lighting device comprising a body, at least one visible light source connected to the body, and at least one ultraviolet light source connected to the body; and
emitting at least one of:
visible light by activating the at least one visible light source; and
ultraviolet light by activating the at least one ultraviolet light source such that a reflectance material of the object, which is not being illuminated by the at least one visible light source, is illuminated by the at least one ultraviolet light source.
